(19) United States
(12) Patent Application Publication
(10) Pub. No.: US 2011/0226841 A1
(43) Pub. Date: Sep. 22, 2011

(54) ROOM TEMPERATURE DIRECT METAL-METAL BONDING

(76) Inventors: Jun Wei, Singapore (SG); Xiao Fang Ang, Singapore (SG); Chee Cheong Wong, Singapore (SG); Zhong Chen, Singapore (SG)

(21) Appl. No.: 13/131,818

(22) PCT Filed: Nov. 27, 2008
(86) PCT No.: PCT/SG08/00448

§ 371 Date: May 27, 2011

(51) Int. Cl. B23K 31/02; B23K 20/02; B32B 15/04; B32B 5/16; C09D 7/12; B82Y 99/00; B82Y 40/00

(52) U.S. Cl. 228/180.22; 228/196; 428/457; 428/327; 428/323; 106/287.32; 977/700; 977/890; 977/734

(57) ABSTRACT

A method for forming direct metal-metal bond between metallic surfaces is disclosed. The method comprises depositing a first nanostructured organic coating (118) on a first metallic surface (116) to form a first passivation layer thereon, the first nanostructured organic coating (118) comprising an organic phase with nanoparticles dispersed within the organic phase, contacting the first nanostructured organic coating (118) with a second metallic surface (126), and applying on the first and second metallic surfaces (116, 126) at least a bonding temperature of at least room temperature and/or a bonding pressure for a bonding period to bond the first and second metallic surfaces (116, 126) thereby forming the direct metal-metal bond therebetween. A second nanostructured organic coating (128) comprising an organic phase with nanoparticles dispersed within the organic phase may also be deposited on the second metallic surface (126).

### FIELD OF INVENTION

The invention relates to a method for forming direct metal-metal bond between metallic surfaces, and in particular, a method for forming direct metal-metal bond between metallic surfaces with the use of a nanostructured organic coating at room temperature. The invention also relates to the nanostructured organic coating for use in the formation of direct metal-metal bond at room temperature. The invention further relates to metallic surfaces coated with the nanostructured organic coating.

### BACKGROUND TO THE INVENTION

The following discussion of the background to the invention is intended to facilitate an understanding of the present invention. However, it should be appreciated that the discussion is not an acknowledgment or admission that any of the material referred to was published, known or part of the common general knowledge in any jurisdiction as at the priority date of the application.

Technology feature sizes continue to shrink to meet the ever-increasing performance demands on integrated circuits. To this end, three-dimensional integrated circuits facilitate dramatic reduction in wiring length by stacking multiple device layers on top of one another through direct metal interconnects which are conventionally accomplished by thermocompression bonding.

Metallic micro-bumps of copper and gold are often favoured for three-dimensional integrated circuit applications due to the strong metallurgical bonds formed as well as their excellent electrical and thermal properties. For example, it has been demonstrated that thermocompression copper/copper direct bonding using a thin layer of tin capped onto copper micro-bumps was formed at 240° C. to 450° C. In the case of gold thermocompression widely used in wire and die bonds, recent surface studies indicate that the gold surface would adsorb organic contaminants when exposed to air. Although these organic contaminants can be removed by ultraviolet-ozone cleaning, this requires bonding temperature of about 300° C. At such high temperatures, thermal stresses may be introduced due to the different materials used in the substrate and metallic bumps, leading to dislocation generation, de-bonding or cracking.

Surface cleanliness is one of the key factors that determine the bonding parameters required to form direct metal-metal bonds. In order to facilitate low bonding temperatures such as room temperature and low bonding pressure, aggressive wet and dry cleaning steps are carried out on the metallic surfaces prior to the bonding to remove oxides and organic contaminants which would otherwise damage the active layers with miniaturized features patterned on a semiconductor wafer.

Since device wafers are typically thinned and hence fragile prior to bonding, it is desirable to operate at low bonding temperatures. Therefore, there is a need to provide a room temperature direct metal-metal bonding between metallic surfaces that overcomes, or at least alleviates, the above problems.

### SUMMARY OF THE INVENTION

Throughout this document, unless otherwise indicated to the contrary, the terms “comprising”, “consisting of”, and the like, are to be construed as non-exhaustive, or in other words, as meaning “including, but not limited to”.

In a first aspect of the present invention, there is provided a method for forming direct metal-metal bond between metallic surfaces. The method comprises:
depositing a first nanostructured organic coating on a first metallic surface to form a first passivation layer thereon, the first nanostructured organic coating comprising an organic phase with nanoparticles dispersed within the organic phase;
contacting the first nanostructured organic coating with a second metallic surface; and

applying on the first and second metallic surfaces at least a bonding temperature of at least room temperature and/or a bonding pressure for a bonding period to bond the first and second metallic surfaces thereby forming the direct metal-metal bond therebetween.

In a second aspect of the present invention, there is provided a method for forming direct metal-metal bond between metallic surfaces. The method comprises:
depositing a first nanostructured organic coating on a first metallic surface to form a first passivation layer thereon, the first nanostructured organic coating comprising an organic phase with nanoparticles dispersed within the organic phase;
depositing a second nanostructured organic coating on a second metallic surface to form a second passivation layer thereon, the second nanostructured organic coating comprising an organic phase with nanoparticles dispersed within the organic phase;
contacting the first nanostructured organic coating with the second nanostructured organic coating; and

applying on the first and second metallic surfaces at least a bonding temperature of at least room temperature and/or a bonding pressure for a bonding period to bond the first and second metallic surfaces thereby forming the direct metal-metal bond therebetween.

In a third aspect of the invention, there is provided a nanostructured organic coating for forming a direct metal-metal bond between metallic surfaces, the nanostructured organic coating comprises an organic phase with nanoparticles dispersed within the organic phase.

In a fourth aspect of the invention, there is provided an article capable of forming a direct metal-metal bond, comprising a metallic surface and a nanostructured organic coating adjacent to the metallic surface comprising an organic phase with nanoparticles dispersed within the organic phase.

### BRIEF DESCRIPTION OF THE DRAWINGS

In the figures, which illustrate, by way of example only, embodiments of the present invention,

FIG. 1 is a schematic illustration of the process steps for forming a direct metal-metal bond between metallic surfaces in accordance with the second aspect of the invention.

FIG. 2 shows the correlation between shear strength of the resultant direct metal-metal bond formed in accordance with the second aspect of the invention and the bonding temperature.

FIG. 3 shows the comparison between the shear strength of the resultant direct metal-metal bond formed in accordance with the second aspect of the invention and the shear strength of the resultant direct metal-metal bond formed without the use of a nanostructured organic coating at temperatures ranging from 60° C. to 140° C.

FIG. 4 is a scanning electron micrograph (SEM) of the resultant direct metal-metal bond formed in accordance with the second aspect of the invention.

### DETAILED DESCRIPTION

The invention relates to a method for forming direct metal-metal bond between metallic surfaces with the use of a nanostructured organic coating at room temperature. Direct metal-metal bonding is a method of joining two metallic surfaces without an intermediate layer in between the metallic surfaces.

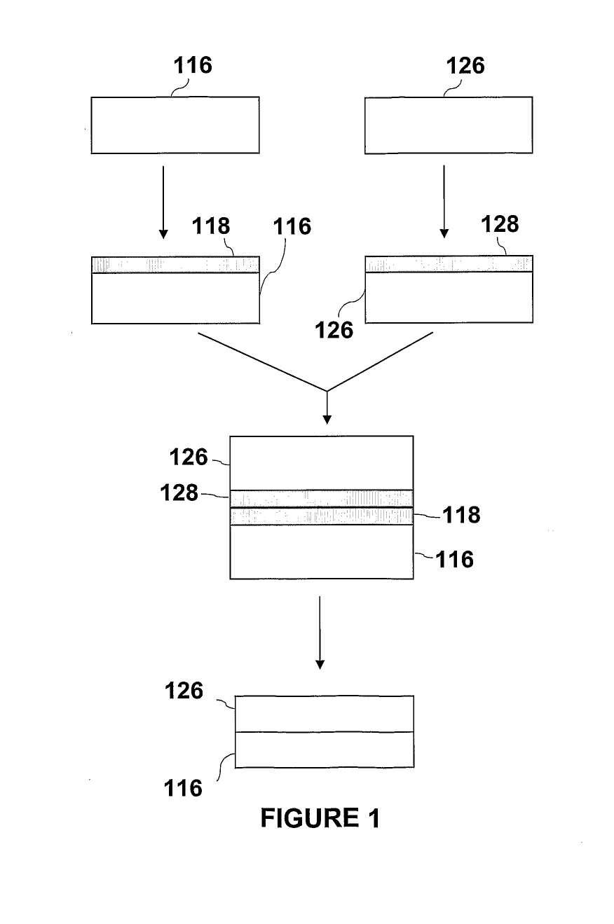

In accordance with a first embodiment of the invention shown in FIG. 1, a first metallic surface 116 and a second metallic surface 126 are each separately provided. The metallic surfaces 116, 126 may comprise elemental metal, intermetallic layers, alloys, or mixture. The first metallic surface 116 and the second metallic surface 126 may form part of a semiconductor chip substrate, for example. A flat and planar metallic surface is shown for the purpose of illustration and it is to be understood that metallic surfaces having other configurations and non-planar surfaces such as bumps and bond pads commonly found in integrated circuits are also possible. The metallic surfaces 116, 126 are preferably cleaned with a cleaning solution to remove oxidation layer or contamination layer formed on the metallic surfaces 116, 126. Cleaning solutions such as acid solutions including sulphuric, hydrochloric, nitric, acetic and phosphoric, and alkaline solutions are suitable. After the cleaning step, the metallic surfaces 116, 126 are preferably flushed with acetone, isopropyl, ethanol, toluene or deionized water to wash out the excess cleaning solution on the metallic surfaces 116, 126. After the flushing step, the metallic surfaces 116, 126 are preferably dry-cleaned with gas blow, plasma etching, laser cleaning, power beam, sandblasting or mechanical removal techniques.

A first nanostructured organic coating 118 is deposited on the first metallic surface 116 to form a first passivation layer. A second nanostructured organic coating 128 is separately deposited on the second metallic surface 126 to form a second passivation layer. The passivation layers act as oxidation barriers so that the underlying metallic surfaces 116, 126 are protected against oxidation. Passivation of the metallic surfaces 116, 126 is crucial; otherwise the oxidized layer formed on the metallic surfaces 116, 126 will not only affect the resultant metal-metal bond integrity and quality but also the thermal and electrical properties of the wafer substrates thereby leading to device deterioration or failure. Preferably, the passivation layers cover the entire metallic surfaces 116, 126. The thickness of the nanostructured organic coating layer is preferably less than 1 μm. Although it has been described that the two metallic surfaces 116, 126 are each deposited with the nanostructured organic coatings, it is to be appreciated that in certain circumstances only one of the metallic surfaces need to be coated. For example, if the first metallic surface 116 is easily oxidized in ambient environment while the second metallic surface 126 is more resistant to oxidation in ambient environment, only the first metallic surface 116 need to be coated with the nanostructured organic coating. The deposition technique includes, but not limited to, immersion, dipping, spraying, ink-jetting, micro-jetting, spin-coating, dispensing, transferring, Langmuir-Blodgett (LB), evaporation, organic molecular beam deposition (OMBD), and ultrahigh vacuum (UHV). The excess nanostructured organic coatings may be removed from the metallic surfaces by rinsing with solvents such as acetone, isopropyl, alcohol, ethanol, or toluene. Preferably, a further drying process is provided to remove the excess solvent.

The nanostructured organic coatings 118, 128 each comprises essentially an organic phase with nanoparticles dispersed within the organic phase. The organic phase comprises organic molecules having particle sizes between 1 nm and 100 nm. Organic molecules having binding affinity to the underlying metallic surfaces are chosen. Such binding affinity may include both physical adsorption processes as well as covalent and ionic forces. The organic molecules may be auto-organizing or otherwise. Examples of the organic molecules include, but not limited to, nucleic acids, trimesic-acid, carboxyl dimer synthon, porphyrin species, carboxyphenyl species, guanine-based tetramers, amino acids, dimerization of cystein molecules, hexanethiol, dodecanethiol, undecanethiol, octadecanethiol, anionic carboxylate species, methionine, carboxylic acids, perylene species, trimellitic acids, terephthalate, organo-silicon monolayers, sulfides, and disulfides.

The nanoparticles dispersed within the organic phase are present in amounts ranging from 0.01 to 10 weight percent (wt %), based on the total weight of the organic phase including the nanoparticles. Preferably, the nanoparticles are present in amounts ranging from 0.1 wt % to 1 wt %. The size of the nanoparticles is less than the surface roughness of the metallic surfaces. Preferably, the size of the nanoparticles ranges from 2 nm to 100 nm. The nanoparticles comprise inorganic, organic, carbon, or mixture. Inorganic nanoparticles include, but not limited to, metal nanoparticles, metal nanowires, metal nanorods, metal nanofibres, metal nanotubes, or mixture. The metal in the inorganic nanoparticles includes, but not limited to, copper, gold, aluminium, nickel, silver, alloy thereof, and mixture thereof. Organic nanoparticles include, but not limited to, polymer nanoparticles. Carbon nanoparticles include, but not limited to, carbon nanotubes, carbon nanofibres, nanofullerenes, nanodendrimers, graphite nanoparticles, or mixture. The nanoparticles are chosen such that the nanoparticles provide a more uniform surface for bonding, thereby improving the resultant metal-metal bond integrity and quality. This will be discussed later in the paragraphs to follow.

After the deposition of the nanostructured organic coatings 118, 128 on the metallic surfaces 116, 126, the first nanostructured organic coating 126 is brought into contact with the second nanostructured organic coating 128 in a mating engagement.

When the nanostructured organic coatings 118, 128 have been brought into contact, a bonding load is applied across the metallic surfaces 116, 126 for a bonding period sufficient to bond the first metallic surface 116 to the second metallic surface 126. The bonding period is less than 1 min. Preferably, the bonding period is between 20 s and 30 s. The bonding technique includes, but not limited to, compression bonding, thermocompression bonding, diffusion bonding, thermosonic bonding and soldering.

The bonding load comprises at least a bonding temperature of at least room temperature or a bonding pressure. Preferably, the bonding pressure is between 0.1 GPa and 10 GPa. Elevated bonding temperatures are also possible since heating improves bond integrity and quality. However, in applications such as the semiconductor industry, since device wafers are typically thinned and hence fragile prior to bonding, it is desirable to operate at low bonding temperatures. The application of the bonding load depends on the bond integrity and quality desired. For example, if high bond strength is needed, both elevated bonding temperatures above room temperature and elevated bonding pressures are applied. If intermediate bond strength is needed, bonding temperature of room temperature and a bonding pressure are applied. If low bond strength is needed, elevated bonding temperature alone is needed. No bonding pressure is applied in this latter case.

The nanostructured organic coating comprises organic molecules whose adhesion to the metallic surface is strong. Because of the strong adhesion, it is not possible for any further substances, specifically contaminants, to be taken up. Furthermore, the binding affinity of such organic molecules to the metallic surface is high, such that the organic molecules will bind to any exposed metallic surface quickly, thereby depleting available metallic surface regions for oxidation. In the case of some organic molecules such as undecanethiol, these organic molecules provide an additional advantage of reducing the metal oxide inevitably formed on the metallic surface before binding to the metallic surface.

The inclusion of nanoparticles further helps to improve the bonding integrity and quality between two metallic surfaces. Due to the inherent properties of the nanoparticles, the nanoparticles have very high surface energy which enables the nanoparticles to be bonded with metallic surfaces at room temperature or low temperatures. A typical metallic surface profile is uneven or rough on close inspection under the SEM. The surface profile resembles undulating terrain of valleys and peaks. A rougher surface is generally depicted by deeper valleys or taller peaks having higher fluctuations over the average surface height. Due to the ultrathin layer of nanostructured organic coating, the organic molecules and the nanoparticles will be forced to take up the valley space when pressure is applied. When bringing the first and second metallic surfaces to close contact, the taller peaks of the first metallic surface will contact the second metallic surface first and vice versa, while neighbouring shorter peaks may or may not contact the mating metallic surface depending on the amount of bonding pressure applied as well as its work hardening behaviour. The addition of nanoparticles is believed to provide a means to reduce asperity and height fluctuations which translate to lower amount of pressure needed to achieve a more uniform surface for bonding. The added nanoparticles fill up the gaps that can potentially be formed between two neighbouring valleys, thus promoting more exposed regions for bonding between the two metallic surfaces. In some cases where the nanoparticles are metals and more preferably, same metals as the metallic surfaces, even stronger bonding strength will be experienced. This also gives rise to yet another advantage of shortening the electron conduction path due to more availability of electron conductors present in the bond.

### Examples

Electroplated copper bumps at bump heights of 18 μm, 92.5 μm in average diameter were fabricated on a silicon substrate. The silicon substrate consisted of sputtered layers on 0.65 mm Si wafer in the following sequence: 50 nm Ti, 100 nm TiW, and 200 nm Au. To remove contaminants on the surfaces, the copper bumps and substrates were acid-cleaned using hydrochloric acid and subsequently flushed with acetone. The cleaned copper bumps and substrates were then immersed in a solution containing 1 mM undecanethiol [CH3(CH2)₁₀SH] with 0.5 wt % copper nanoparticles for 2 h. The coated copper bumps and substrates were then re-immersed in another fresh solution containing 1 mM undecanethiol [CH3(CH2)₁₀SH] with 1 wt % copper nanoparticles for 15 min to saturate the surfaces to be bonded. Bonding of the copper bumps between two substrates was performed using flip-chip bonder at constant load at 88.9 N, bonding pressure of 3.28 GPa and bonding period of 30 s at room temperature (approximately 25° C.) under ambient condition of about 70% relative humidity. The experiment was then repeated at 40° C., 60° C., 80° C., 100° C. and 140° C., all other parameters remain unchanged. Several minutes were necessary for the bonder to heat and cool to the set temperature. No additional cleaning steps besides solvent rinsing were employed. After the bonding step, the bonded samples were subjected to a shear strength test using a dynamic mechanical analyzer.

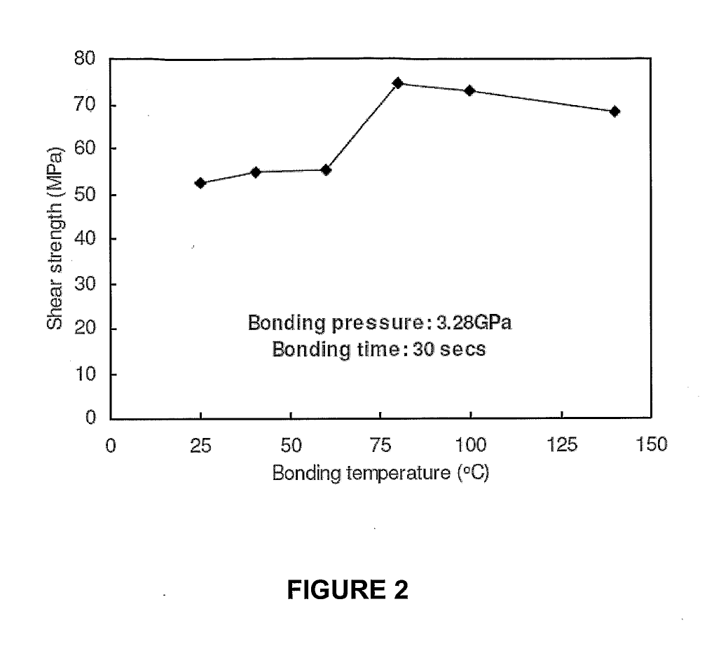

The shear strength results for the above experiments are depicted in FIG. 2, where the room temperature bonding gives bond strength of about 50 MPa. The highest bond strength of about 75 MPa occurs at 80° C.

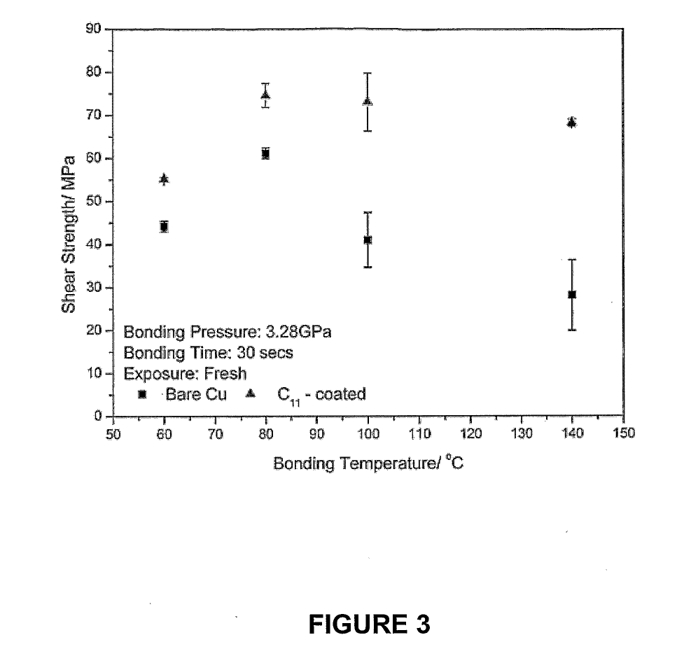

The above experiments were bench-marked against bare copper bumps without the nanostructured organic coating. All the experimental parameters remained the same except no immersion in the nanostructured organic solution was carried out. The shear strength results for this bench-marking exercise are depicted in FIG. 3, where the range of bonding temperatures for measurable shear strength varies from 60° C. to 140° C. Shear strength at bonding temperature below 60° C. was too low to be measured. As clearly evident from FIG. 3, the deposition of the nanostructured organic coating on copper bumps (legend: C₁₁-coated) yields much improved bond strength and integrity compared to bare copper bumps (legend: Bare Cu).

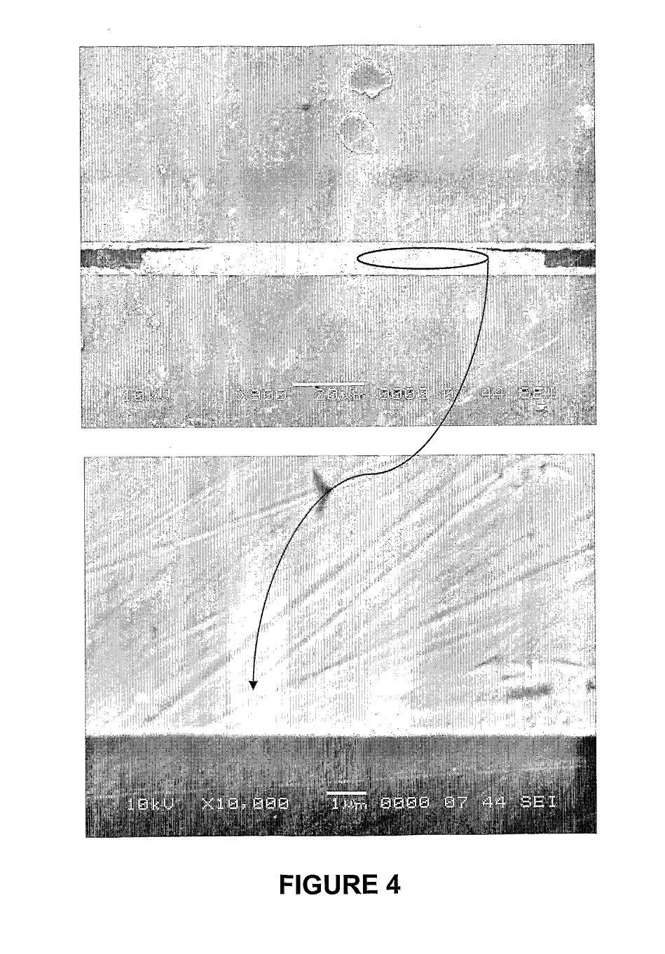

FIG. 4 depicts the SEM of the room temperature bonding of the copper bumps on silicon substrates performed in the experiment described above. From the top SEM, it is clear that no cracks were observed at the underlying silicon substrates at room temperature bonding. More importantly, in the bottom SEM which shows a magnified section of the bonded copper bumps of the top SEM, the arrow indicates the disappearance of the bonding interface. This shows that direct metal-metal bond without an intermediate layer has been obtained.

The invention is applicable to the manufacture of semiconductor devices, electronic devices, optoelectronic devices, micro-electro-mechanical systems (MEMS), micro-optoelectro-mechanical systems, three-dimensional integrated circuits, systems-in-package, and multi-functional systems.

The invention also finds uses in other similar devices or systems that require direct metal-metal bond integration, such as metal joining of aerospace components for aerospace industry and metal welding of automobile parts.

The afore-described method provides a simple and economical way of forming a direct metal-metal bond having good bonding integrity and quality such as high bond strength of at least 50 MPa with the use of a combination of organic molecules and nanoparticles forming the nanostructured organic coating between metallic surfaces. Advantageously, the bonding is formed at room temperature, although elevated temperatures are also possible. Further, each individual process step, being simple and easy to perform, is compatible with existing bonding techniques and equipments so that the bonding process can be carried out at low cost without much modification to the processing line or equipments. The organic molecules forming the organic phase and the nanoparticles are commercially available reagents and are therefore easily available.

Although the foregoing invention has been described in some detail by way of illustration and example, and with regard to one or more embodiments, for the purposes of clarity of understanding, it is readily apparent to those of ordinary skill in the art in light of the teachings of this invention that certain changes, variations and modifications may be made thereto without departing from the spirit or scope of the invention as described in the appended claims.

1-42. (canceled)

43. A method for forming direct metal-metal bond between metallic surfaces, the method comprising:
depositing a first nanostructured organic coating on a first metallic surface to form a first passivation layer thereon, the first nanostructured organic coating comprising an organic phase with nanoparticles dispersed within the organic phase;
contacting the first nanostructured organic coating with a second metallic surface; and
applying on the first and second metallic surfaces at least a bonding temperature of at least room temperature and/or a bonding pressure for a bonding period to bond the first and second metallic surfaces thereby forming the direct metal-metal bond therebetween.

44. A method for forming direct metal-metal bond between metallic surfaces, the method comprising:
depositing a first nanostructured organic coating on a first metallic surface to form a first passivation layer thereon, the first nanostructured organic coating comprising an organic phase with nanoparticles dispersed within the organic phase;
depositing a second nanostructured organic coating on a second metallic surface to form a second passivation layer thereon, the second nanostructured organic coating comprising an organic phase with nanoparticles dispersed within the organic phase;
contacting the first nanostructured organic coating with the second nanostructured organic coating; and
applying on the first and second metallic surfaces at least a bonding temperature of at least room temperature and/or a bonding pressure for a bonding period to bond the first and second metallic surfaces thereby forming the direct metal-metal bond therebetween.

45. The method recited in claim 43, wherein the first nanostructured organic coating comprises 0.01 wt % to 10 wt % nanoparticles dispersed within the organic phase.

46. The method recited in claim 45, wherein the first nanostructured organic coating comprises 0.1 wt % to 1 wt % nanoparticles dispersed within the organic phase.

47. The method recited in claim 44, wherein the second nanostructured organic coating comprises 0.01 wt % to 10 wt % nanoparticles dispersed within the organic phase.

48. The method recited in claim 47, wherein the second nanostructured organic coating comprises 0.1 wt % to 1 wt % nanoparticles dispersed within the organic phase.

49. The method recited in claim 43, wherein the size of the nanoparticles ranges from 2 nm to 100 nm.

50. The method recited in claim 43, wherein the thickness of the first or second nanostructured organic coating is less than 1 μm.

51. The method recited in claim 43, wherein the nanoparticles are selected from the group consisting of inorganic nanoparticles, organic nanoparticles, carbon nanoparticles, and mixture thereof.

52. The method recited in claim 51, wherein the inorganic nanoparticles are selected from the group consisting of metal nanoparticles, metal nanowires, metal nanorods, metal nanofibres, metal nanotubes, and mixture thereof.

53. The method recited in claim 52, wherein the metal in the inorganic nanoparticles is selected from the group consisting of copper, gold, aluminium, nickel, silver, alloy thereof, and mixture thereof.

54. The method recited in claim 51, wherein the organic nanoparticles comprises polymer nanoparticles.

55. The method recited in claim 51, wherein the carbon nanoparticles are selected from the group consisting of carbon nanotubes, carbon nanofibres, nanofullerenes, nanodendrimers, graphite nanoparticles, and mixture thereof.

56. The method recited in claim 43, wherein the organic phase of the first or second nanostructured organic coating is selected from the group consisting of nucleic acids, trimesic-acid, carboxyl dimer synthon, porphyrin species, carboxyphenyl species, guanine-based tetramers, amino acids, dimerization of cystein molecules, hexanethiol, dodecanethiol, undecanethiol, octadecanethiol, anionic carboxylate species, methionine, carboxylic acids, perylene species, trimellitic acids, terephthalate, organo-silicon monolayers, sulfides, disulfides, and mixture thereof.

57. The method recited in claim 43, wherein the bonding pressure is below 10 GPa.

58. The method recited in claim 57, wherein the bonding pressure is between 0.1 GPa and 3.28 GPa.

59. The method recited in claim 43, wherein the bonding period is less than 1 min.

60. The method recited in claim 59, wherein the bonding period is between 20 s and 30 s.

61. The method recited in claim 43, wherein the metal in the first metallic surface and the metal in the second metallic surface are each selected from the group consisting of copper, gold, aluminium, nickel, silver, alloys thereof, and mixture thereof.

62. The method recited in claim 43, wherein the first metallic surface is formed on a first substrate and the second metallic surface is formed on a second substrate.

63. The method recited in claim 62, wherein the first and second substrates are each selected from the group consisting of electronic chip, electronic device, optoelectronic chip, optoelectronic device, microsystem wafer, nanosystem wafer, printed circuit board, glass substrate, and ceramic substrate.

64. A nanostructured organic coating for forming a direct metal-metal bond between metallic surfaces, the nanostructured organic coating comprises an organic phase with nanoparticles dispersed within the organic phase.

65. The nanostructured organic coating recited in claim 64, comprising 0.01 wt % to 10 wt % nanoparticles dispersed within the organic phase.

66. The nanostructured organic coating recited in claim 65, comprising 0.1 wt % to 1 wt % nanoparticles dispersed within the organic phase.

67. The nanostructured organic coating recited in claim 64, comprising nanoparticles having sizes ranging from 2 nm to 100 nm.

68. The nanostructured organic coating recited in claim 64, wherein the nanoparticles are selected from the group consisting of inorganic nanoparticles, organic nanoparticles, carbon nanoparticles, and mixture thereof.

69. The nanostructured organic coating recited in claim 68, wherein the inorganic nanoparticles are selected from the group consisting of metal nanoparticles, metal nanowires, metal nanorods, metal nanofibres, metal nanotubes, and mixture thereof.

70. The nanostructured organic coating recited in claim 69, wherein the metal in the inorganic nanoparticles is selected from the group consisting of copper, gold, aluminium, nickel, silver, and mixture thereof.

71. The nanostructured organic coating recited in claim 70, wherein the organic nanoparticles comprises polymer nanoparticles.

72. The nanostructured organic coating recited in claim 68, wherein the carbon nanoparticles are selected from the group consisting of carbon nanotubes, carbon nanofibres, nanofullerenes, nanodendrimers, graphite nanoparticles, and mixture thereof.

73. The nanostructured organic coating recited in claim 64, wherein the organic phase is selected from the group consisting of nucleic acids, trimesic-acid, carboxyl dimer synthon, porphyrin species, carboxyphenyl species, guanine-based tetramers, amino acids, dimerization of cystein molecules, hexanethiol, dodecanethiol, undecanethiol, octadecanethiol, anionic carboxylate species, methionine, carboxylic acids, perylene species, trimellitic acids, terephthalate, organo-silicon monolayers, sulfides, disulfides, and mixture thereof.

74. An article capable of forming a direct metal-metal bond, comprising a metallic surface and a nanostructured organic coating adjacent to the metallic surface wherein the nanostructured organic coating comprises an organic phase with nanoparticles dispersed within the organic phase.

75. The article recited in claim 74, comprising 0.01 wt % to 10 wt % nanoparticles dispersed within the organic phase.

76. The article recited in claim 75, comprising 0.1 wt % to 1 wt % nanoparticles dispersed within the organic phase.

77. The article recited in claim 74, comprising nanoparticles having sizes ranging from 2 nm to 100 nm.

78. The article recited in claim 74, wherein the nanoparticles are selected from the group consisting of inorganic nanoparticles, organic nanoparticles, carbon nanoparticles, and mixture thereof.

79. The article recited in claim 78, wherein the inorganic nanoparticles are selected from the group consisting of metal nanoparticles, metal nanowires, metal nanorods, metal nanofibres, metal nanotubes, and mixture thereof.

80. The article recited in claim 79, wherein the metal in the inorganic nanoparticles is selected from the group consisting of copper, gold, aluminium, nickel, silver, and mixture thereof.

81. The article recited in claim 78, wherein the organic nanoparticles comprises polymer nanoparticles.

82. The article recited in claim 78, wherein the carbon nanoparticles are selected from the group consisting of carbon nanotubes, carbon nanofibres, nanofullerenes, nanodendrimers, graphite nanoparticles, and mixture thereof.

83. The article recited in claim 74, wherein the organic phase is selected from the group consisting of nucleic acids, trimesic-acid, carboxyl dimer synthon, porphyrin species, carboxyphenyl species, guanine-based tetramers, amino acids, dimerization of cystein molecules, hexanethiol, dodecanethiol, undecanethiol, octadecanethiol, anionic carboxylate species, methionine, carboxylic acids, perylene species, trimellitic acids, terephthalate, organo-silicon monolayers, sulfides, disulfides, and mixture thereof.

84. The article recited in claim 74, wherein the metal in the metallic surface is selected from the group consisting of copper, gold, aluminium, nickel, silver, alloys thereof, and mixture thereof.
